(19) United States
(12) Patent Application Publication
(10) Pub. No.: US 2015/0245364 A1
(43) Pub. Date: Aug. 27, 2015

(54) RADIO RESOURCE MANAGEMENT

(71) Applicant: HEWLETT-PACKARD DEVELOPMENT COMPANY, L.P., Houston, TX (US)

(72) Inventors: Robert D. Yacovitch, Dollard-des-Ormeaux (CA); Vincent Derive, Laval (CA)

(21) Appl. No.: 14/378,661

(22) PCT Filed: Feb. 16, 2012
(86) PCT No.: PCT/US12/25484

§ 371 Date: Aug. 14, 2014

(51) Int. Cl. H04W 72/08; H04W 24/10

(52) U.S. Cl. CPC H04W 72/082; H04W 24/10; H04W 88/08

(57) ABSTRACT

A method, computer readable medium and system for radio resource management are disclosed. The method may include obtaining, for each AP of a network of APs, measurements of relative signal strengths of other APs or the network and RF noise, as sensed by that AP. The method may also include, based on a model, providing a prediction of an operation performance of that AP with respect to one or more channel or power parameters.

### BACKGROUND

IEEE 802.11 is a set of standards for implementing wireless local area network (WLAN) computer communications. The frequency bands allocated for IEEE 802.11 include the 2.4, 3.6 and 5 GHz frequency bands, These standards provide the basis for wireless network products under the brand name “Wi-Fi”.

The IEEE 802.11 standards use over-the-air modulation techniques under the same basic protocol.

The performance of an 802.11 wireless network is critically dependent on an optimal channel/power assignment for the access points (APs) in the network, Published guidance and rules of thumb for 802.11 wireless network-design do not take into account the specific capabilities in the high-speed improvements in the latest amendments to IEEE 802.11 (e.g. 802.11g and 802.11n).

### BRIEF DESCRIPTION OF THE DRAWINGS

Examples are described in the following detailed description and illustrated in the accompanying drawings in which:

FIG. 1A illustrates a standardized 802.11 cell, in accordance with an example;

FIG. 1 illustrates a standardized 802.11 cell affected by radio-frequency (RF) noise, in accordance with an example;

FIG. 2A illustrates a densely deployed plurality of APs;

FIG. 2B illustrates the co-channel APs of the densely deployed plurality of APs shown in FIG. 2A;

FIG. 3 illustrates The co-channel APs of FIG. 2B, after power reduction of two APs, in accordance with an example;

FIG. 4 illustrates the AP network shown in FIG. 2A, with a controller, in accordance with an example;

FIG. 5 illustrates a method for radio resource management, according to an example.

### DETAILED DESCRIPTION

In the following detailed description, numerous specific details are set forth. However, it will be understood by those skilled in the art that other examples may be practiced without these specific details. In other instances, well-known methods, procedures, and components have not been described in detail so as not to obscure the described examples or other examples.

Although examples are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method examples described herein are not constrained to a particular order or sequence. Additionally, some of the described method examples or elements thereof can occur or be performed at the same point in time.

Unless specifically stated otherwise, as apparent from the following discussions, it is appreciated that throughout the specification, discussions utilizing terms such as “adding”, “associating” “selecting,” “evaluating,” “processing,” “computing,” “calculating,” “determining,” “designating,” “allocating” or the like, refer to the actions and/or processes of a computer, computer processor or computing system, or similar electronic computing device, that manipulate, execute and/or transform data represented as physical, such as electronic, quantities within the computing system's registers and/or memories into other data similarly represented as physical quantities within the computing system's memories, registers or other such information storage, transmission or display devices.

The channel/power assignment problem for an IEEE 802.11 wireless network is usually addressed a weighted graph coloring optimization problem. In graph theory, graph coloring is a special case of graph labeling. It involves assigning labels which are referred to as “colors” to elements of the graph subject to various constraints. The nodes of the graph represent the wireless APs. The arcs of the graph represent neighboring AP relationships. The weights are commonly the relative signal strengths between the APs. The various colors represent the various available 802.11 channels. Graph coloring algorithms work reasonably well for sparse AP deployments. However, in dense deployments, the solutions may become less optimal. Further, graph coloring algorithms typically assume a ‘static’ network topology, with little to no consideration devoted to the channel-specific RF environment in the site.

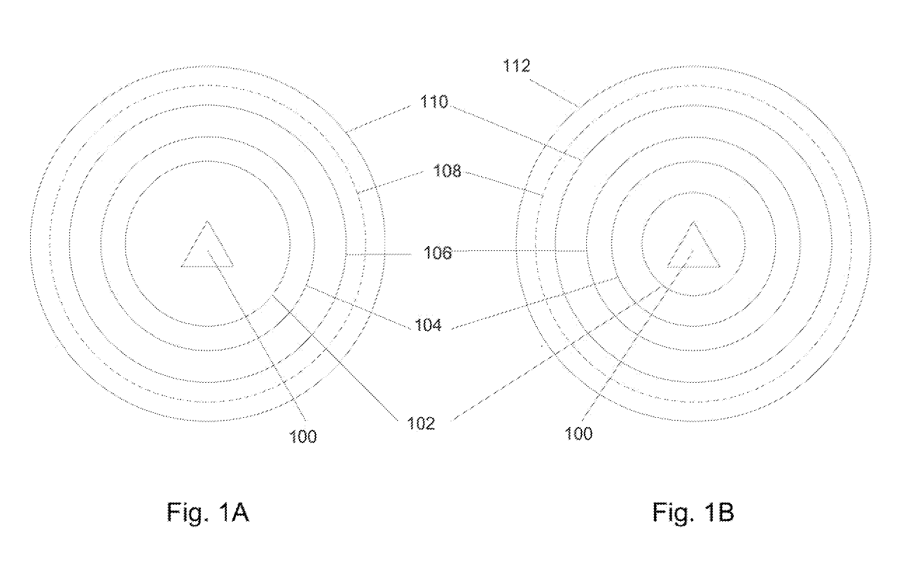

FIG. 1A illustrates a standardized 802.11 cell, in accordance with an example. A concept of a ‘Standardized 802.11 Cell’ may be defined, associated with a predetermined spatial extent, and a model for predicting network performance metrics within the cell may be considered. According to some examples, the standard weighted graph coloring optimization algorithm is modified to include channel quality metrics predictors to adjust the weighting factors in the usual algorithm.

As the strength of an RF signal is inversely proportional to the distance square in free space from the location of the transmission point (100), the predetermined spatial extent of a standardized 802.11 cell may arbitrarily be set to be the periphery of the reception range of the radio at the center of that cell at which the usable data rate is half the highest data rate. The spatial extent is marked in FIG. 1A (and FIG. 1B) by dashed circle line 108.

The model predicting network performance metrics within the cell may take into account key determinants for predicting performance, such as, for example: (1) 802.11 characteristics (80211a/b/g and the various 802.11n high performance schemes); (2) the transmission power; (3) RF interference resulting from other neighboring 802.11 APs; (4) non-802.11 RF noise sources. In general, all these determinants vary if the channel of operation of that AP is changed.

FIG. 1A illustrates the modeled performance of the Standardized 802.11 Cell. Here circles of different radii represent the operating ranges of the AP when transmitting at various data rates (E.g., 102=54 Mega-bytes per second, Mbps, 104=48 Mbps, 106=36 Mbps, 110=24 Mbps, 112=18 Mbps).

The model may be used to calculate the radius of each circle (i.e., the spatial extent for each given transmission rate). Table 1 shows the results of an example of such a calculation.

TABLE 1

| | | 802.11a (5 GHz band) | | | 802.11g (2.4 GHz band) | | |
|---|---|---|---|---|---|---|---|
| Data Rate | Receiver | | | Average | | | Average |
| (Mbps) | Sensitivity | Radius | Area | Data Rate | Radius | Area | Data Rate |
| 54 | −65 | 1.000 | 1.000 | 54.00 | 1.000 | 1.000 | 54.00 |
| 48 | −66 | 1.077 | 1.160 | 53.17 | 1.086 | 1.179 | 53.09 |
| 36 | −70 | 1.450 | 2.102 | 45.48 | 1.509 | 2.276 | 44.85 |
| 24 | −74 | 1.951 | 3.808 | 35.86 | 2.096 | 4.394 | 34.80 |
| 18 | −77 | 2.438 | 5.946 | 29.44 | 2.683 | 7.197 | 28.26 |
| 12 | −79 | 2.829 | 8.003 | 24.95 | 3.162 | 10.000 | 23.70 |
| 9 | −81 | 8.282 | 10.771 | 20.85 | 3.728 | 13.895 | 19.58 |
| 6 | −82 | 3.535 | 12.496 | 18.80 | 4.047 | 16.379 | 17.52 |

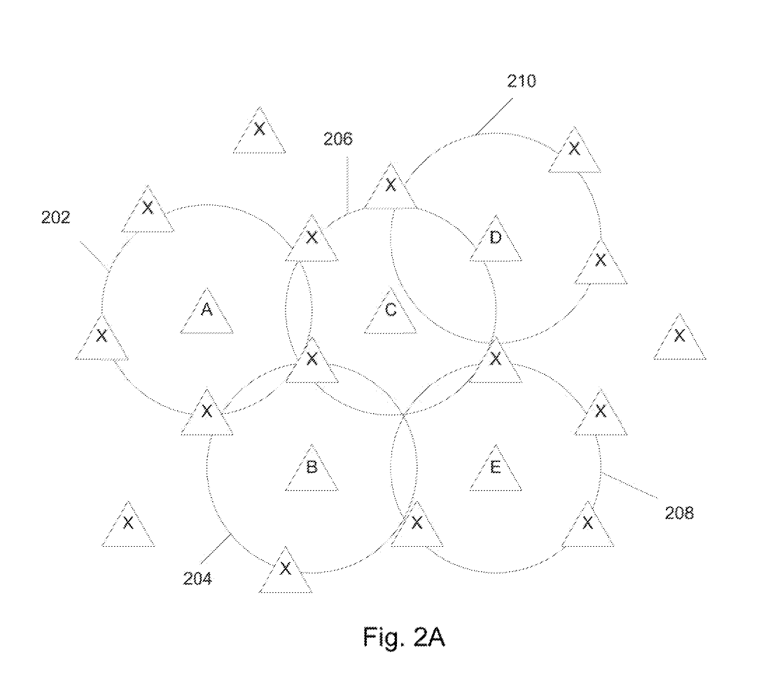

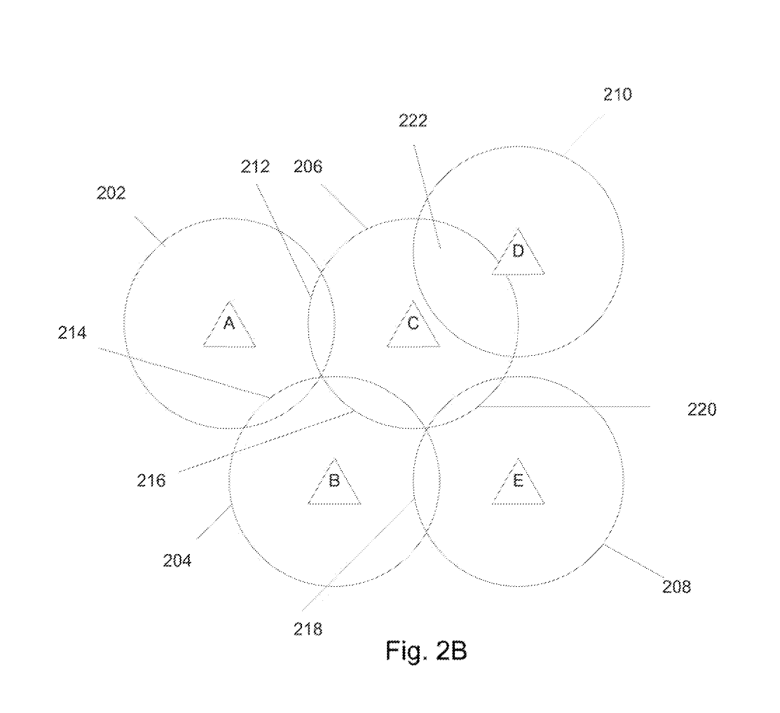

In the presence of RF noise, the operating ranges of the AP for each data-rate are reduced. FIG. 2B shows the effect of RF noise. The radius of all the rings decreases. The outermost area of the “cell” is now operable at the rate 112 (18 Mbps).

In real-world deployment, however, walls and other obstructing objects may get in the way. Also radio-frequency (RF) signal propagation indoors is very variable and is affected by walls, the wall material, floors, furniture, electrical and electronic equipment and even by people who are present.

Performance metrics may be normalized to a best-case performance achievable in an ideal RF environment, with reference to a fixed nominal maximum transmit power. Table 2 shows the model output-performance degradation versus RF noise.

TABLE 2

| Noise | 802.11a | 802.11g |
|---|---|---|
| (dB) | (5 GHz band) | (2.4 GHz band) |
| 1 | 93.1% | 92.7% |
| 2 | 87.2 | 86.5 |
| 3 | 82.1 | 81.2 |
| 4 | 77.7 | 76.7 |
| 5 | 73.9 | 72.9 |
| 6 | 70.8 | 69.7 |
| 7 | 67.8 | 67.0 |
| 8 | 65.4 | 64.7 |
| 9 | 63.3 | 62.7 |
| 10 | 61.5 | 61.0 |

It is evident from Table 2 that the greater the RF noise the greater the performance degradation of the AP. For example, when the AP experiences RF noise of 1 dB the performance degradation is in the order of 7% (6.9% in the 5 GHz band, and 7.3% in the 2.4 GHz band). When the AP experiences RF noise of 10 dB the resulting performance degradation is substantially greater—in the order of 40% (38.5% in the 5 GHz band and 39.0% in the 2.4 GHz band).

FIG. 2A illustrates a scenario of a real-world network with relatively densely deployed APs. In general there are not enough RF channels to assign every AP a unique channel. For example, in the 2.4 GHz band, there are only three non-overlapping channels available. In the example of FIG. 2A, a particular channel-assignment pattern is shown, where APs marked A through E are assigned the same channel (hereinafter referred to as “co-channel Aps”). The APs marked X are assigned different channels. This is just an example of a channel assignment pattern, and other channel assignment patterns are possible as well.

FIG. 2B illustrates the scenario of FIG. 2A but shows only the co-channel APs. In the example shown in this figure it is evident that there is some RF interference between the APs in the periphery of their respective coverage zones, which may cause some level of packet loss when two or more APs transmit at the same time. Thus, AP A and AP B interfere in an overlapping periphery 214, AP a and AP C interfere in an overlapping periphery 212, AP B and AP C interfere in an overlapping periphery 216, AP B and AP E interfere in an overlapping periphery 218, AP E and AP C interfere in an overlapping periphery 220 and AP D and AP C interfere in an overlapping periphery 222. However, while the interference between APs A, B, C and E is confined to small peripheries, the interference between APs C and D is substantially greater and involves a substantial overlapping portion 222 of the effective coverage zones of these APs.

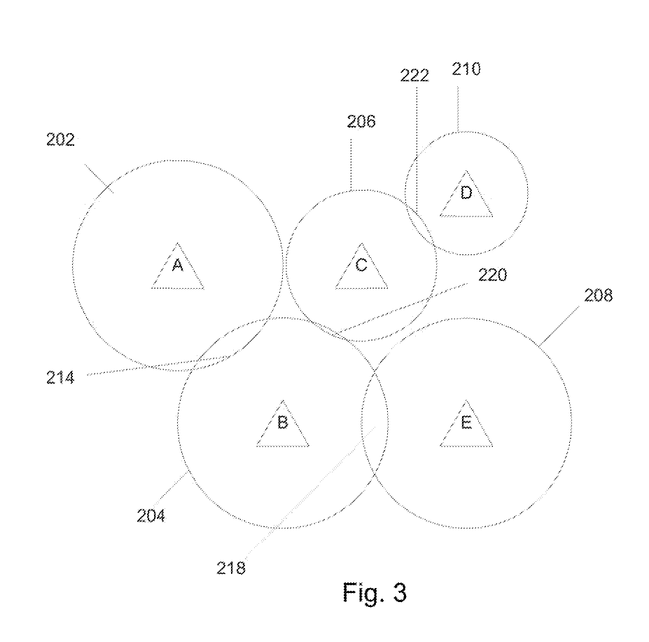

In accordance with some examples, adjacent APs may be classified as follows: a. nearby neighbors (e.g., C and D) that hear a strong signal from each other (refer to the large overlap 222 between the effective coverage zones 206 and 210 of APs C and D), who have to share the same RF channel, i.e., they take turns in transmitting packets. In effect, each AP (C and D) may be forced to operate half of the time; and b. remote neighbors (e.g. A and E) that hear only a very weak signal from each other (overlaps 212, 214, 216, 218, 220 between the effective coverage zones 202, 204, 206 and 208). If the signal strength is low enough, they will transmit at the same time. The weak signals will slightly degrade the signal-to-noise ratio (SNR), which will degrade the performance of each cell. For example, each AP may be able to operate at a slightly reduced rate (e.g. 95% of the best-case rate), within its cell. The interference between APs C and is particularly severe as they are very close. In accordance with some examples, a method for radio resource management may include reducing the transmit power of AP D or both APs C and D so as to reduce or eliminate the overlap between the effective coverage zones of these APs, and thus reduce or eliminate interference between the two APs. This situation is depicted in FIG. 3. In FIG. 3 the co-channel APs of FIG. 2B is shown, after power reduction of two APs, in accordance with some examples. Reducing the transmit power of AP D and AP C is done so as to prevent channel sharing. As a result there is only a small overlap zone 220 between AP C and AP B, and a small overlap zone 222 between the effective coverage zones of AP D and AP C, both of which are substantially smaller than the corresponding overlaps shown in FIG. 2B. Furthermore, in the situation depicted in FIG. 3 there exist no overlap between the effective coverage zones of AP C and AP A and between AP C and AP E.

However, reducing the power reduces the performance within each cell. In this example, AP C may be able to operate at a reduced rate, e.g. 80%, of its best-case performance and AP D at a reduced rate too, e.g. 60%. So the total performance for the pair of APs in this example would be 140% (versus 100% for channel sharing).

The relative signal strength of each of the APs as it is sensed by each of the APs of the network, may have a substantial influence on interference between APs. The relative signal strength of each of the APs may be determined from measurements taken by the APs in the network.

For example, signal-strength of neighboring APs may be measured by any of the 802.11 HW chipsets (RSSI—Received Signal Strength Indication). An RSSI value is provided with every frame received by the 802.11 HW. RF-noise may be measured by operating 802.11 HW chipset in a “spectrum analysis” mode or using a separate sensor.

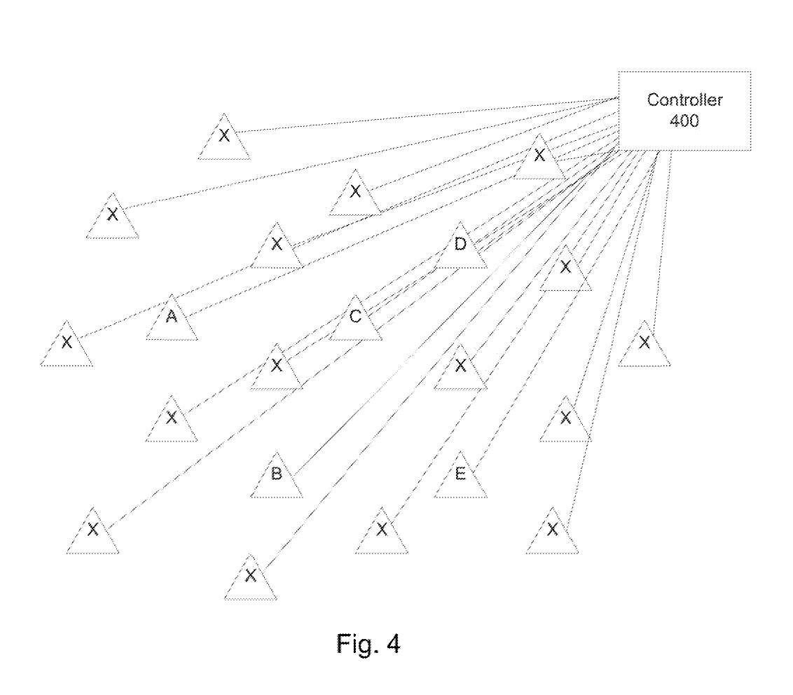

FIG. 4 illustrates the AP network shown in FIG. 2A, with a controller 400, in accordance with some examples, in communication with the APs of the network (Xs, A, B, C, E in this example). The controller may be designed to execute a method for radio resource management, according to some examples. The method may be implemented, for example, in the form of an algorithm and may be realized in the controller and/or in the APs (and/or using additional components and/or devices) as hardware, software or a combination of both.

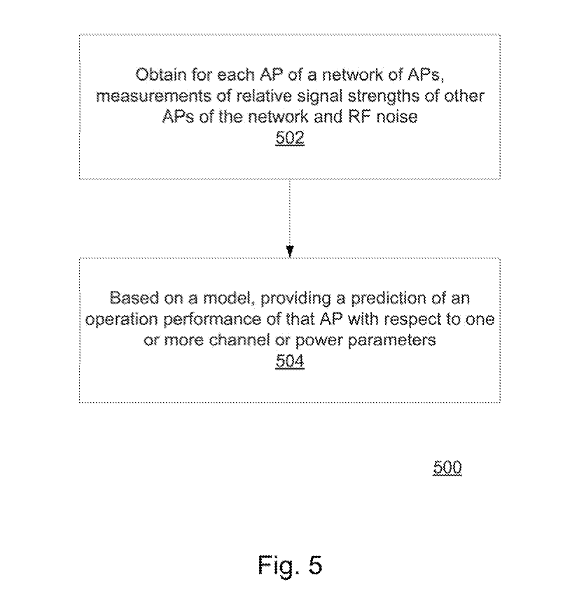

FIG. 5 illustrates a method 500 for radio resource management, according to an example.

A method 500 for radio resource management, according to some examples, may include obtaining 502, for each AP of a network of APs, measurements of relative signal strengths of other APs of the network and RF noise, as sensed by that AP. The method may also include, based on a model, providing 504 a prediction of an operation performance of that AP with respect to one or more channel or power parameters. In some examples the channel or power parameters may be selected from the group of parameters that includes currently assigned channel for that AP, currently assigned channel for one or more neighboring APs, currently assigned power for that AP, currently assigned power for one or more neighboring APs, alternative channel assignment for that AP, alternative channel assignment for one or more neighboring APs, alternative power assignment for for that AP and alternative power assignment for one or more neighboring APs.

According to some examples, such method may include predicting, based on the measurements and on the model, operation performance of some or all of the APs of the network of APs.

According to examples, the method may include using the prediction in determining weights for solving a weighted graph coloring optimization problem.

In some examples, the method may include calculating a channel quality metric and using the calculated channel quality metric in solving the weighted graph coloring optimization problem.

In some examples, the method may include using a controller communicating with the each AP of the network of APs to obtain the measurements and to provide the prediction.

The method may, according to some examples, include using the controller to adjust channel or power of one or more APs of the network of APs, based on the prediction.

Further, according to some examples, the method may include adjusting channel or power of one or more APs of the network of APs, based on the prediction.

In some examples, APs may be classified as “nearby neighbors” or “remote neighbors” (see the description above), and for remote neighbors, a value for RF noise may be estimated. For example, a case of “remote neighbors” whose signal-strength is very low may be considered. Signal-strength is a direct measurement of the RF-power in the frame received. RF-noise is, by definition, the RF-power present in the environment which “corrupts” any RF-signal. It may be assumed that the remote neighbor may be transmitting at the same time as the AP (or one of the AP's clients), and thus the remote “signal” acts as “noise” and corrupts the AP or client's signal. Thus, the RF-noise estimate is equal to the RF-signal power from that remote neighbor.

A threshold (e.g. the CCA threshold in 802.11) may be used as a prime criterion.

According to some examples, adjusting the power of co-channel APs of the network based on the measurements may be performed periodically, from time to time arbitrarily or in a predetermined repeating manner. In some examples, a fuzzy-logic approach of the adjustment of the power of the co-channel APs may be taken, to “smooth” power changes. Thus, for example, the two APs of an AP pair may be classified as being 80% nearby neighbors and 20% remote neighbors. The fuzzy-logic approach makes the proposed method more stable to minor measurement variations in real-world measurements. The fuzzy-logic approach may also facilitate more stable power adjustments.

Thus, when solving a weighted graph coloring optimization algorithm channel quality metrics predictors may be used to adjust the weighting factors in the algorithm. The weights are now variable and dependent on the channel/power choices for the APs in the network.

In some examples, the model calculations may be summarized in a set of lookup tables accessed by the optimization algorithm. With such an implementation, there are many possible enhancements that can easily be accommodated.

In accordance with examples, a channel quality metric may be used to represent the performance estimate of a channel. In general the best channel to assign would be the one with the highest (potential) throughput. Channel quality metrics may be determined by each AP gathering raw information and using this raw information to estimate the channel impairment/degradation (which reduces the potential throughput from the best case). Thus, an AP may gather raw measurements of the signal strength of neighboring APs and RF noise from several APs sources and these measurements may be combined into channel-quality metrics for all potential (in-band) operating channels for each AP. If an AP includes multiple radios, raw measurements may be gathered separately for each radio of that AP and analysis of these measurements may be done independently for each radio.

Typically, Averaged values of the raw measurements may be used to calculate channel-quality metrics. In some examples, a short-term averaging time period (e.g. 30 seconds) may be used for calculating ‘instantaneous’ channel quality metrics. The short-term averaging period would be long enough so that background scanning can provide reasonably accurate results for non-operating channels. In some cases, there may be a need for faster results for the operating channel, thus choosing very short short-term averaging time periods (e.g. a 2-second averaging time period).

Long-term averaging time periods may be used in determining channel and power assignment according to examples. Typically, radio resource management (RRM) channel and power assignment algorithms may be executed when the AP network is the quietest—e.g., at night or during weekends. The RF environment at that time is not representative of a typical, active network.

To compute long-term averages for RRM purposes, the following algorithm may be considered: 1) for each measured value (per radio), an hourly average for the value (of the measurement, e.g. signal strength, RF noise) would be computed; 2) a table of 24 per-hour buckets (e.g. a table with 24 slots, with each slot indexed by the hour-of-the-day) for every measured value would be maintained. In some examples, the bucket period may be configurable; 3) at the end of each hour the average value shall be combined into the appropriate bucket. Each bucket may be treated as a ‘leaky-bucket’, used to estimate the weekly average for that hour of the day. A bucket value may be computed using the relation: Bucket=current value+(6/7) Bucket. The averaging period may be configurable, but for many purposes a default averaging period of 7 days is suitable. In some examples, a different or separate mechanism to track day-of-week averaging may be provided.

In some examples, the average number of associated clients for each hour, per each radio, may be computed. According to examples, the controller (e.g. 400 in FIG. 4) may aggregate the client counts per radio across the network as a whole. For example, the following relation may be used:

System-Clients[h]=Sum (Average-Clients[h, r]) summed over all radios, where: h is the hour of the day (e.g., 0-23); and r is a specific radio index number.

According to examples, a system-wide weighting table may be generated (e.g. by the controller) based on the system-wide client counts. The following relations may be used:

Total-Client-Hours=Sum(System-Clients [h]), summed for 24 hours

Weight[h]=System-Clients[h]/Total-Client-Hours

A weighting table may be generated for each AP/radio periodically (e.g. on a daily or hourly basis). The weighting table for each AP/radio may be used to compute a weighted-average of the bucketized measurement values to be used by an RRM algorithm. The controller may save the weighting table (in flash memory) periodically (e.g. daily). Each AP of the AP network may save the bucket tables periodically (e.g. daily), for example, in flash memory.

According to some examples, each AP of the AP network may collect and maintain a table of neighbor beacon frames received from other APs of the network. Such table of neighbor beacon frames may include information for channels in the same band (e.g. 2.4 GHz or 5 GHz) as the AP radio's operating channel. The table of neighbor beacon frames may include information for channels in an alternate band (e.g. 2.4 GHz or 5 GHz).

The table of neighbor beacon frames may include the following information:

a. Full beacon frames;

b. A time-stamp relating to the time the most recent beacon frame was received;

c. A time-stamp relating to the time when the first beacon frame was received from that neighbor AP;

d. Average receive signal strength (e.g., in dBm frames transmitted by a particular neighbor AP.

The table of neighbor beacon frames may include information on frames from co-channel APs, received by the radio in its assigned channel. The table of neighbor beacon frames may include information on frames from the non-operating channels, received via “channel scanning”.

In some examples, an AP of the AP network may make use of spectrum analysis capabilities of a chipset and driver used in the AP network to estimate an average non-802.11 noise in each potential operating channel. An AP may measure an average “media access delay” for frames transmitted by the radio (the average media access delay is one of the measurements defined in 802.11k).

In estimating channel quality the following effects may be considered:

1. Channel sharing: When nearby APs operate on the same channel, they will typically share the RF bandwidth. This happens when the mutual signal strength between the APs is greater than the CCA threshold.

2. Strong RF noise: The AP will ‘defer’ transmission if it detects are RF signal greater than the CCA threshold. This noise could originate from 802.11 sources—e.g., when operating in the 24 GHz band, nearby APs may be using overlapping channels. The noise could also originate from non-802.11 sources (microwave ovens, Bluetooth devices, etc).

3. Weak RF noise: RF noise less than the CCA threshold reduces SNR between 802.11 stations. This may lead to increased frame loss, and perhaps operation at lower data rates.

When an AP has M neighbor APs operating on the same channel, channel degradation may be expected for example for the following reasons:

1. Sharing channel with neighbor APs reduces the channel availability by a factor of: 1/(1+M).

2. Sharing the channel with neighbor APs may cause collisions. For small M, with all APs active, the collision rate is approximately (M−1)/CWmin, where CWmin is the minimum contention window size (e.g., 32 in 802.11b, and 16 in 802.11a). Thus, collisions reduce the, successful frame delivery rate by a factor of (1−[M−-1]/CWmin).

An AP would defer packet transmission if it detects an RF signal which is above the CCA threshold. If strong noise is present for a fraction (BUSY) of the time, the channel availability is reduced by a factor of (1−BUSY).

RF noise decreases the probability of successful frame delivery. This reduces the delivery rate by some factor, dependent on the average noise power “NOISE”:F(NOISE). Here, F( ) is a function of the noise power.

Combining these effects, allows defining the following channel quality metric:

METRIC1=1/(1+M)*(1−[M−1]/CWmin) (1−BUSY)*F(NOISE) Where M=Estimated number of co-channel neighbors: BUSY=Estimated fraction of the time that there is RF noise above the CCA threshold; NOISE=Average total noise power (in dBm) below the CCA threshold: CWmin=The minimum contention window size, 32 in 802.11b and 16 in 802.11a; F( . . . )=Estimated channel degradation factor due to RF noise.

METRIC1 may be interpreted as the fraction of air time that can be used by the AP to successfully transmit data to clients in the AP cell.

Estimating M-co-channel neighbors: Frames (beacons, typically) from co-channel neighbors may be ‘heard’. If they are strong enough (above a certain threshold), the APs would need to share the channel. Per 802.11-2007, when operating with CCA Mode 1 enabled, the RF medium must be considered busy if the energy detected is above a CCA threshold. The standard requires a minimum CCA threshold as follows:

>−80 dB (if transmitter power>100 mW)

>−76 dBm (transmitter power>50 mW and 100 mW)

>−70 dBm (trans titter power under 50 mW)

Thus, assuming a transmit power of 18 dBm (˜64 mW), the CCA threshold would be −76 dBm and the channel would have to be shared if the neighbor AP is heard at −76 dBm or louder. To avoid sharp transitions, fuzzy logic may be considered:

−82 dBm or lower . . . 0.0 Neighbors

−81 dBm . . . 0.1 Neighbors

−80 dBm . . . 0.2 Neighbors

−79 dBm . . . 0.3 Neighbors

−78 dBm . . . 0.4 Neighbors

−77 dBm . . . 0.5 Neighbors

−76 dBm . . . 0.6 Neighbors—assumed CA threshold

−75 dBm . . . 0.7 Neighbors

−74 dBm . . . 0.8 Neighbors

−73 dBm . . . 0.9 Neighbors

−72 dBm or higher . . . 1.0 Neighbors

Given a list of neighbor APs, and the signal strength, the potential co-channel neighbors “M1” may be calculated for each potential channel. Note that, because of the fuzzy logic, M1 is not necessarily a whole number.

Nearby neighbor APs operating in overlapping channels (e.g., in the 2.4 GHz band) and adjacent channels (e.g., in the 5 GHz) band may also ‘inject’ RF energy into the channel at signal levels which exceed the CCA threshold. The channel-to-channel spectral overleap may be calculated, and this allows adjusting a neighboring AP's receive power to take into account the effect of the spectral overlap.

Similarly, using fuzzy logic as above, the potential overlapping/adjacent neighbors “M2” may be estimated.

The estimated number of neighbors is M=(M1+M2).

Some examples may be embodied in the form of a system, a method or a computer program product. Similarly, some examples may be embodied as hardware, software or a combination of both. Some examples may be embodied as a computer program product saved on one or more non-transitory computer readable medium (or mediums) in the form of computer readable program code embodied thereon. Such non-transitory computer readable medium may include instructions that when executed cause a processor to execute method steps in accordance with examples. In some examples the instructions stores on the computer readable medium may be in the form of an installed application and in the form of an installation package.

Such instructions may be for example loaded into one or more processors and executed.

For example, the computer readable medium may be a non-transitory computer readable storage medium. A non-transitory computer readable storage medium may be, for example, electronic, optical, magnetic, electromagnetic, infrared, or semiconductor system, apparatus, or device, or any combination thereof.

Computer program code may be written in any suitable programming language. The program code may execute on a single computer, or on a plurality of computers.

Examples are described hereinabove with reference to flowcharts and/or block diagrams depicting methods, systems and computer program products according to examples.

What is claimed is:

1. A method for radio resource management comprising:
obtaining, for each AP of a network of APs, measurements of relative signal strengths of other APs of the network and RF noise, as sensed by that AP; and
based on a model, providing a prediction of an operation performance of that AP with respect to one or more channel or power parameters.

2. The method of claim 1, wherein said one or more channel or power parameters is a currently assigned channel for that AP, a currently assigned channel for one or more neighboring APs, a currently assigned power for that AP, a currently assigned power for one or more neighboring APs, an alternative channel assignment for that AP, an alternative channel assignment for one or more neighboring APs, an alternative power assignment for that AP or an alternative power assignment for one or more neighboring APs.

3. The method of claim 1, further comprising predicting, based on the measurements and on the model, operation performance of some or all of the APs of the network of APs.

4. The method of claim 1, further comprising using the prediction in determining weights for solving a weighted graph coloring optimization problem.

5. The method of claim 4, further comprising calculating a channel quality metric and using the calculated channel quality metric in solving the weighted graph coloring optimization problem.

6. The method of claim 1, comprising using a controller communicating with the each AP of the network of APs to obtain the measurements and to provide the prediction.

7. The method of claim 1, further comprising adjusting channel or power of one or more APs of the network of APs, based on the prediction.

8. A non-transitory computer readable medium having stored thereon instructions for radio resource management, which when executed by a processor cause the processor to perform the method of:
obtaining, for each AP of a network of APs, measurements of relative signal strengths of other APs of the network and RF noise, as sensed by that AP; and
based on a model, providing a prediction of an operation performance of that AP with respect to one or more channel or power parameters.

9. The non-transitory computer readable medium of claim 8, wherein said one or more channel or power parameters is a currently assigned channel for that AP, a currently assigned channel for one or more neighboring APs, a currently assigned power for that AP, a currently assigned power for one or more neighboring APs, an alternative channel assignment for that AP, an alternative channel assignment for one or more neighboring APs, an alternative power assignment for that AP or an alternative power assignment for one or more neighboring APs.

10. The non-transitory computer readable medium of claim 8, wherein the method further comprises predicting, based on the measurements and on the model, operation performance of some or all of the APs of the network of APs.

11. The non-transitory computer readable medium of claim 8, the method further comprising using the prediction in determining weights for solving a weighted graph coloring optimization problem.

12. The non-transitory computer readable medium of claim 11, the method further comprising calculating a channel quality metric and using the calculated channel quality metric in solving the weighted graph coloring optimization problem.

13. The non-transitory computer readable medium of claim 8, wherein the method further comprises using a controller communicating with the each AP of the network of APs, to obtain the measurements and to provide the prediction.

14. The non-transitory computer readable medium of claim 13, therein the method further comprises using the controller to adjust channel or power of one or more APs of the network of APs, based on the prediction.

15. A system for radio resource management comprising:
a controller to:
communicate with each AP of a network of APs;
obtain, for each AP of the network of APs, measurements of relative signal strengths of other APs of the network and RF noise, as sensed by that AP; and
based on a model, provide a prediction of an operation performance of that AP with respect to one or more channel or power parameters.

16. The system of claim 15, wherein said one or more channel or power parameters is a currently assigned channel for that AP, a currently assigned channel for one or more neighboring APs, a currently assigned power for that AP, a currently assigned power for one or more neighboring APs, an alternative channel assignment for that AP, an alternative channel assignment for one or more neighboring APs, an alternative power assignment for that AP or an alternative power assignment for one or more neighboring APs.

17. The system of claim 15, wherein the controller is configured to predict, based on the measurements and on the model, operation performance of some or all of the APs of the network of APs.

18. The system of claim 15, wherein the controller is configured to use the prediction in determining weights for solving a weighted graph coloring optimization problem.

19. The system of claim 18, wherein the controller is configured to calculate a channel quality metric and using the calculated channel quality metric in solving the weighted graph coloring optimization problem.

20. The system of claim 15, wherein the controller is configured to adjust channel or power of one or more APs of the network of APs, based on the prediction.
